(19) United States
(12) Patent Application Publication
(10) Pub. No.: US 2024/0099287 A1
(43) Pub. Date: Mar. 28, 2024

(54) MEASURING PROBE FOR A SPINNING OR CASTING ROD

(71) Applicant: Djup AB, STOCKHOLM (SE)

(72) Inventor: Christer Chytraéus, STOCKHOLM (SE)

(21) Appl. No.: 18/257,118

(22) PCT Filed: Nov. 8, 2021
(86) PCT No.: PCT/SE2021/050991

§ 371 Date: Jun. 13, 2023

(30) Foreign Application Priority Data
Dec. 17, 2020 (SE) 2051486-5

(51) Int. Cl. A01K 91/20; G01S 15/08

(52) U.S. Cl. CPC A01K 91/20; G01S 15/08

(57) ABSTRACT

The invention relates to measuring probe (100) for a spinning or casting rod (1) comprising a housing (101) with connection means (102a, 102b) on the housing (101) for securing the measuring probe (100) to a fishing line (2) of the rod (1) above the lure (3). The sensors include at least one of: an accelerometer (104), a gyroscope (105), a water pressure sensor (112), and an active sonar unit (111). The measuring probe (100) further comprises a wireless communication unit (108), preferably Bluetooth for transmitting stored sensor data to an external device when the measuring probe (100) is above the water surface (5), and a battery (110) for powering the measuring probe (100).

### TECHNICAL FIELD

The invention relates to measuring probe for a spinning or casting rod. The invention further relates spinning or casting rod including a rod with a fishing line and a lure secured to the end of the fishing line. The invention further relates to a method providing a spinning or casting rod with a fishing line, and a lure to the end of the fishing line.

### BACKGROUND

Today there is a variety of equipment, both of a stationary and more mobile nature, to measure the depth from the water's surface down to the bottom. There is also equipment to provide an accurate picture of bottom structures and to be able to locate fish.

WO2017112778 disclose an angling sensing device on a fishing rod. US2018288990 disclose sensor assembly for a castable lure. The sensor assembly is attached to the end of the fishing line.

US2015342169 disclose a lure with sensors. US2019072951 disclose a castable sonar device.

JP2013179901A disclose a communication terminal including sensors for float fishing. The communication terminal is anchored to the middle of the fishing line and functions as a float itself or together with a float above the water surface.

### OBJECT OF THE INVENTION

It is an object to determine the travelling depth of any lure.

It is another object to determine travelling depth of the lure in different water environments.

### SUMMARY OF THE INVENTION

The invention relates to the measuring probe initially mentioned comprising:
a housing;
connection means on the housing for securing the measuring probe to a fishing line of the rod above the lure;
at least one of:
an accelerometer for measuring acceleration forces in three axes,
a gyroscope to determine the angular position of the measuring probe,
a water pressure sensor, and
an active sonar unit;
a wireless communication unit, preferably Bluetooth for transmitting stored sensor data to an external device when the measuring probe is above the water surface; and
a battery for powering the measuring probe.

This provides a probe that can more accurately track the water depth of the lure. it can also be combine sonar and water pressure data to track the water depth. The sonar unit can also be used to measure the distance between the lure and bottom structure. Furthermore, it can be used with any kinds of lures and thereby increasing the likelihood of a successful catch. Loss of the measuring probe is further reduced by having the sensors separate from lure.

Preferably the housing has a nose in a travelling direction and a tail for facing the lure. Preferably the tail is tapering towards the lure. This reduces the drag coefficient.

Preferably the housing is elongated. An elongated shape reduces the drag coefficient.

Alternatively, the housing is spherical.

Preferably, the drag coefficient of the housing is less than 0.5 in Re ^{˜}10⁴.

In some examples the drag coefficient of the housing is less than 0.2 in Re ^{˜}10⁴, preferably less than 0.1 in Re ^{˜}10⁴.

Preferably, the density of the probe is within the range of 0.5-2 g/cm³.

Preferably, the measuring probe is configured to move in a stable position such that it does not rotate around the axis that would coincide with a stretched fishing line attached to the probe. such that a first lengthwise half of the housing can face the water surface (although with an angle), when traveling through the water.

Preferably, the weight of the measuring probe is distributed towards a second lengthwise half of the housing, such that at least two thirds of the weight is in the second half.

Preferably, the battery is provided in the second half.

Preferably, the active sonar unit is configured, once submerged, to send ultrasonic pulses towards the water surface and to receive returning pulses from the water surface for determining the distance from the measuring probe to the water surface. The sonar unit can also be used to measure the distance between the lure and bottom structure.

Preferably, the connection means comprises a through hole at each short end of the housing, through which through holes a fishing line can be drawn through, a first through hole for facing a fishing rod and a second through hole for facing a lure.

The housing may have a visual identification on the along the top of the first half to guide the user when threading the fishing line.

The housing may have a lengthways trace at the top of the first half running between the through holes to guide the fishing line.

The measuring probe may further comprise one or more of the following sensors:
a magnetometer for measuring the direction of the probe in earths magnetic field;
two electrodes for measuring the conductivity of the water, preferably determining a pH value of the water;
a light sensor for measuring the turbidity and/or color of the water; and
a thermometer for measuring the temperature of the water.

The invention further relates to the spinning or casting rod initially mentioned where the measuring probe is secured to the fishing line between the tip of the rod and the lure at a predetermined distance from the lure.

The invention further relates to the method initially mentioned where the measuring probe being secured to the fishing line between the tip of the rod and the lure at a predetermined distance from the lure.

The method may further include the steps of:
measuring acceleration forces in three axes affecting the measuring probe;
measuring an angular position of the measuring probe;
measuring a water pressure.

The method may further include the steps of
sending ultrasonic pulses towards the water surface and/or to the bottom;
receiving returning ultrasonic pulses from the water surface and/or to the bottom;
determining a distance from the measuring probe to the water surface and/or the bottom at least partly based on data from ultrasonic the ultrasonic pulses.

Preferably, determining a depth of the lure based on:
a) information of angular position of the probe;
b) the water pressure and/or the ultrasonic determined distance from the measuring probe to the water surface; and
c) the distance between the lure and the measuring probe.

The method may further comprise one or more of the following steps:
measuring the direction of the probe in earths magnetic field;
measuring the conductivity of the water, preferably determining a pH value of the water;
measuring the turbidity of the water;
measuring the temperature of the water;
storing sensor data; and
transmitting stored sensor data to an external device when the measuring probe is above the water surface.

### BRIEF DESCRIPTION OF THE DRAWINGS

FIG. 1 disclose an angler using a spinning or casting rod with a measuring probe attached to a fishing line

FIG. 2A disclose the probe and its components according to an embodiment seen from above;

FIG. 2B is a sideview of the probe of FIG. 2A;

FIG. 3 show the probe and lure in water sending sonar pulses; and

FIG. 4 show the probe and lure in water.

FIG. 5A-C shows examples of the shape of the probe.

### DETAILED DESCRIPTION

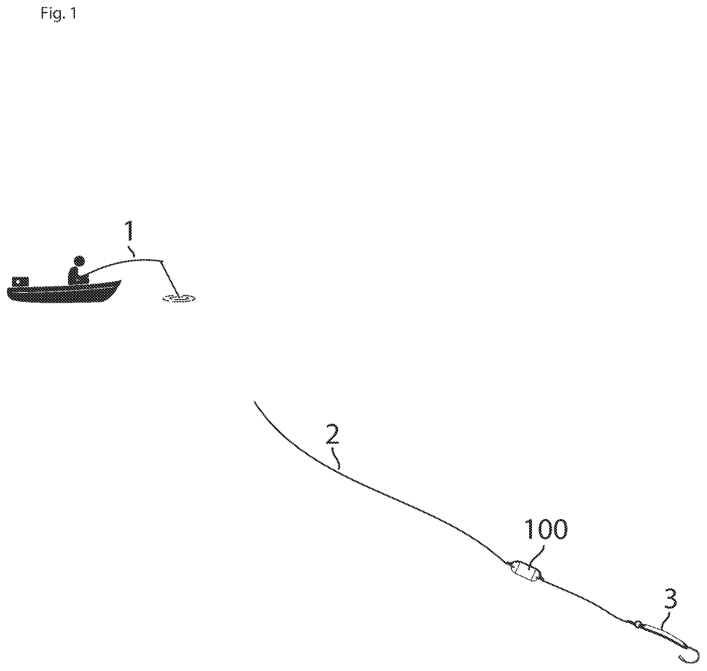

FIG. 1 shows an angler holding spinning or casting rod 1 with a fishing line 2 and a lure 3 at the distal end of the fishing line 2. A measuring probe 100 is secured to the fishing line 2 at a position between the lure 3 and the tip of the rod 1. The measuring probe 100 has a range of features, including the capacity of determining the depth in which the lure 3 has travelled.

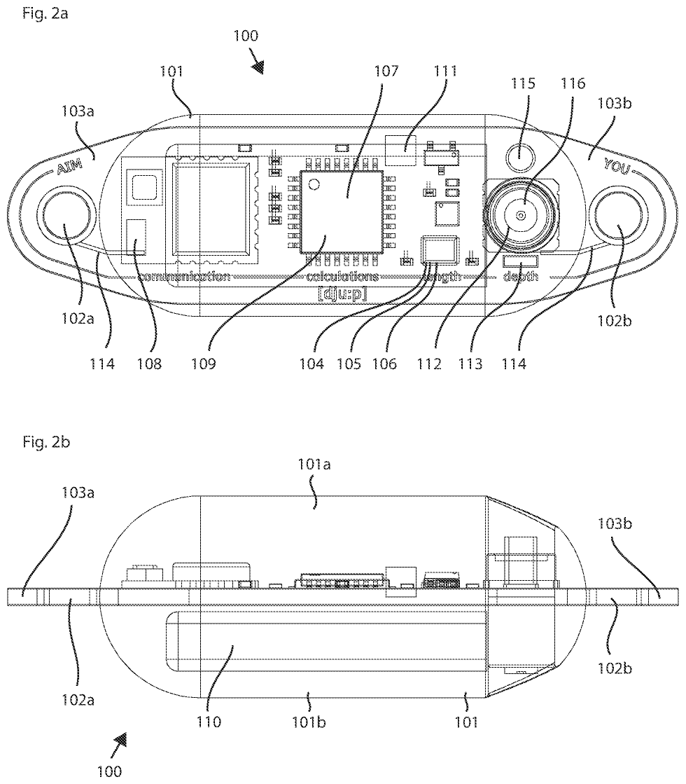

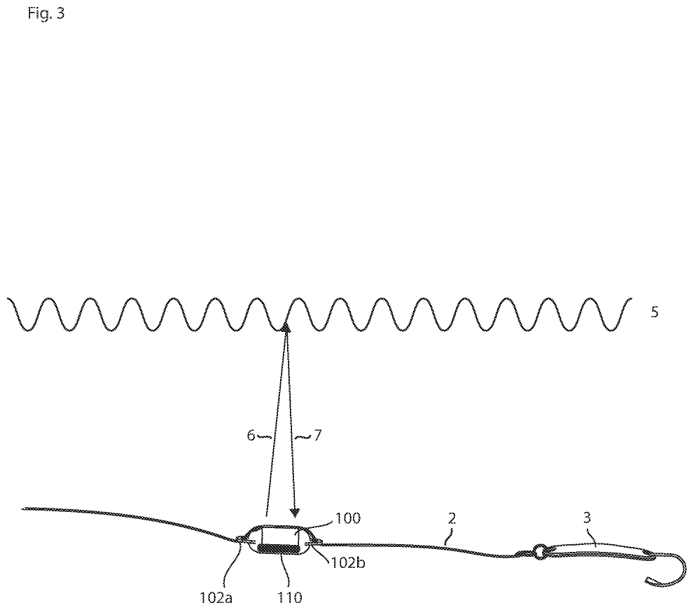

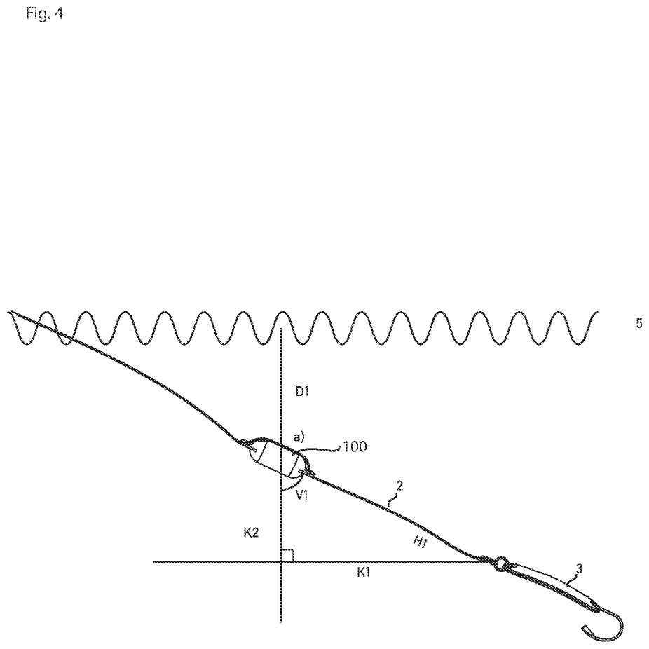

As can be seen in FIGS. 1-4, the measuring probe 100 comprises an elongated housing 101. The elongated housing 101 preferably has a spherocylindrical shape to provide a smooth run in the water without spinning or wobbling. The smooth run of the measuring probe 100 does not attract fish and hence does not steal focus from the lure.

The measuring probe 100 is secured to the fishing line 2. Connecting means in the form of a through hole 102a, 102b is provided in a protruding tab 103a, 103b at each short end of the elongated housing 101. The fishing line 2 is drawn through the through holes 102a, 102b at each short end before attaching the lure 3 to the end of the fishing line 2. It is sufficient to draw the fishing line 2 through the holes 102a, 102b without loops or knots and only gently stretch the line 2 to secure the measuring probe 100 to the fishing line 2. The distance between the probe 100 and the lure 3 may be in the range of 0-150 cm, preferably 0-100 cm.

The line elasticity holds the measuring probe 100 in place without the need for any knots This makes it easy to attach the measuring probe 100 to the fishing line 2 and removes weaknesses in the fishing line 2 created by loops or knots. Other means of the attaching the probe 100 to the fishing line 2 are conceivable, for instance where the probe is attached on a fishing line already carrying a lure 3.

The elongated housing 101 with the through holes 102a, 102b at the short ends ensures that the measuring probe 100 travels through the water essentially at the same angel V1 as the fishing line 2. The angle V1 can therefore be used to determine the depth of the lure 3, as will be explained below.

Furthermore, the by having the lure 3 after the measuring probe 100, and not integrated in the lure 3, a wide variety of lures 3 can be used and they can easily be replaced without affecting the measuring probe 100. Furthermore, a loss of the lure 3 does not mean a loss of the measuring probe 100. The measuring probe 100 can further easily be moved up and down along the line 2 to adjust for heavier or lighter lures 3.

The elongated housing 101 have first lengthwise half 101a and a second lengthwise half 101b. By threading the fishing line 2 over the first half 101a, gravity will urge this side to face upwards when the measuring probe 100 is pulled by the fishing line 2 in water. To further aid the measuring probe 100 to have a stable and upright position, with the first half 101a facing upwards, the weight of the measuring probe 100 is distributed towards the opposite second lengthwise half 101b. Preferably, such that at least two thirds of the weight is in the second half 101b. This can for instance be achieved by putting a battery 110 of the measuring probe 100 in the second half 101b.

The first half 101a may have having a visual identification to guide the user to thread the fishing line 2 on top of that part. The first half 101a may further have lengthwise trace on top of that part running between the through holes 102a, 102b to guide the fishing line 2.

The shape of the housing 101 in combination with the line 2 drawn on top of the first half 101a and the weight distribution distributed to the second half 101b provides for a stable movement of the measuring probe 100 in the water. The stable movement minimises the risk that the measuring probe 100 attracts fish and steal attention from the lure 3 and makes it possible to send sonar pulses towards the water surface.

The position of the measuring probe 100 on the fishing line 2 shall be between the lure 3 and the tip of the rod 1. The distance between the measuring probe 100 and the lure 3 can be determined by e.g. a mark on the rod 1. The position of the measuring probe 100 on the line 2 means that the operation of the lure 3 is not affected by the measuring probe. The position of the measuring probe 100 on the line 2 means that the focus remains on the lure 3.

If the distance between the measuring probe 100 and the lure 3 is known (e.g. by a mark on the fishing rod 1) and is fed into the software, the relative depth of the lure 3 to the measuring probe 100 can be determined by means of a gyroscope, even though the position of the measuring probe 100 is not exactly at the lure 3.

The position of the measuring probe 100 on the fishing line 2 allows it to provide accurate measurements of both movement, distance and depth, without the impact of the lure 3 on it.

The position of the measuring probe 100 means that any loss of lure 3 does not have to mean loss of the measuring probe 100 itself.

It should be noted that measuring probe 100 is not integrated in the lure 3. By having the measuring probe above the lure 3, the angler can select and change the lure 3 as he or she like.

Furthermore, since the rod 1 itself does not need to have the any measuring equipment attached to it, there is nothing to cause the angler to experience imbalance in the management of his fishing equipment.

The measuring probe 100 comprises a water pressure sensor 112, an active sonar unit 111, accelerometer 104, a gyroscope 105, a wireless communication unit 108, a microprocessor 109, a data storage unit 107, a battery 110. The probe may be equipped with less sensors than shown, but preferably includes at least one from the following list: a water pressure sensor 112, an active sonar unit 111, accelerometer 104, and a gyroscope 105.

The water pressure sensor 112 and the active sonar unit 111 can be used to measure, individually or combined, the depth of the measuring probe 100 and thereby the depth of the lure 3, and/or it's distance from the bottom structure

The water pressure sensor 112 measures the hydrostatic pressure changes in the water.

The active sonar unit 111 sends ultrasonic pulses 6 towards the water surface 5 and/or the bottom structure and receives returning pulses 7 from the water surface 5 and/or bottom structure. It can thereby measure the distance from the measuring probe 100 to the water surface 5 and/or to the sea bottom. Hence, unlike ordinary sonar which measures the distance to the bottom, the measuring probe 100 measures the distance to the water surface 5 and/or the distance from the lure 3 to the bottom structure.

The measurement of water depth preferably takes place by combining water pressure data and sonar data, but they can also be used independently of one another. The combined depth measurement by water pressure and sonar data gives a more accurate measurement result, especially at times when one of the measuring methods is affected by external circumstances. For instance, the hydrostatic pressure is not significantly affected by terrain or density changes in the aquatic environment, whereas ultrasonic measurements of water depth are independent of water current movements.

The accelerometer 104 enables the measuring probe 100 to measure movements (G-forces) in the directions X, Y, Z. The accelerometer 104 can be e.g. used to determine when a lure 3 is cast. The measurement is done by identifying a sudden increase in movement in a particular direction. The accelerometer 104 is further used to measure the length of the cast, from the start of the cast until the measuring probe 100 hits the water surface 5. The distance can be determined by using the measurement of acceleration and speed, multiplied by the time between the beginning and end of the cast. The accelerometer 104 is further used to measure the speed of the underwater travel of the measuring probe 100. Timestamps are assigned to each cast and retrieve from the time the measuring probe 100 hits the water surface 5 until it comes back out of the water surface 5 together with data on movement from the accelerometer 104. The accelerometer 104 is further used to record movements of a more sudden nature, which occur during the retrieve, i.e. from, for example, cutting from fish or contact with the seabed.

The gyroscope 105 can measure the angle V1 of the measuring probe 100 when it travels above and below water. Due to the shape of the probe 100, the angle V1 will be more or less the same as the angle of the fishing line 2 to the lure 3 when travelling through the water. Hence, by knowing the angle V1 of the measuring probe 100 in the water the exact depth of the lure 3 can be calculated if the distance H1 between the measuring probe 100 and the lure 3 is known. The calculation of the exact depth is done by adding K2 to the depth D1 of the measuring probe 100, where K2=H1*cos (v1).

Another advantage with a gyroscope 105, is that the measuring probe 100 can detect that it has stayed in a certain position for a long time. E.g. if the measuring probe 100 has lost contact with the fishing line 2 and floated to the surface. This can be used by the measuring probe 100 to send a signal, for instance a flashing light, so that it easier can be recovered.

The measuring probe 100 can further be equipped with magnetometer 106, to measure the geographical direction of the probe (North, South, Southwest, etc.) as it travels above and below the water's surface 5. The geographical direction of casts and retrieves can be connected with digital maps using a mobile device's GPS and provide precise position and precise angle at casts and retrieves.

The measuring probe 100 is further equipped with a thermometer 116 to measure water temperature and temperature differences at different depths and positions in the water. In the shown example the thermometer 116 is integrated with the pressure sensor 112. Knowing temperature differences at different depths and geographical positions can be of great benefit to the angler.

The measuring probe 100 can further be equipped with two electrodes 114 for measuring the conductivity of the water, preferably for determining a pH value of the water. Information about water acidity in combination with external GPS (mobile phone) provides valuable data for both the angler and for third parties, as each angler becomes a measuring station.

The measuring probe 100 can further be equipped with a light sensor 113 and a LED light 115 for measuring the turbidity and/or color of the water. This can measure different aspect of turbidity, but also which color the water has. For example, how brown the water is, how much algae etc.

The measuring probe 100 is equipped with the data storage unit 107 to store information temporarily and divide data from the different sensors into “time markers” from the cast until the measuring probe 100 comes out of the water surface. The time markers are divided by x number at cast, from start to the measuring probe 100 hitting the water surface 5. And x number of time markers during the retrieving, from the measuring probe 100 hitting the water surface until it comes up again. For each time marker, data from all sensors, e.g. accelerometer, magnetometer, gyroscope, thermometer, sonar, and pressure sensor are stored. By collecting all the data into separate time markers, one can also determine the different geographical positions for depth, temperature, direction, movement and speed changes.

The measuring probe 100 is preferably configured for wireless charging.

The gyroscope 105 can determine the angle along the axle defined coinciding with the fishing line. Preferably the gyroscope is MEMS-based, and more preferably a three-axis MEMS-based gyroscope.

The measuring probe 100 is further equipped with a wireless communication unit 108 to transfer stored information to a mobile device. This can be done by e.g. Bluetooth, but of course other wireless transmission means cab be used

The microprocessor 109 controls the units in the measuring probe 100. It may be provided with a software which combines data from the sensors and calculate different values, e.g. data from accelerometer and time markers can determine values about speed. Data can also be uploaded to an external device for further processing, e.g. a mobile phone device.

The measuring probe 100 can be used in a method to estimate depth of fishing lure 3 in real time and displaying it on a user device, e.g. a mobile phone. In the method, data from a first throw is used, to estimate the subsurface depth of the probe 100 and thereby the lure 3 in the throws that follows the first throw.

For each throw the estimate can be further improved by comparing the estimated depth with the measured depth. For instance, calculation of sinking velocity can be done in a software application by determining, after a first throw, how deep the probe 100 sank in the first seconds of the start of the throw, after it landed in the water.

This function (sink velocity of the probe 100) can be used to show the angler an estimated depth of the lure 3 in real time, on a user device (e.g. a mobile phone), while the throw is still in progress and the lure 3 and probe 100 are still below the water surface. The software application may learn that the probe 100 (and thereby the lure 3) ended up in the water because the wireless connection was broken. The Probe may also send a signal to the phone that it hit the water, but before submerging. The estimated depth calculation can thus start automatically and show the estimated depth in real time, as the lure 3 and probe 100 sinks. This is of great benefit to the angler, who can begin to roll back the lure 3 when it has reached the desired depth.

Other data can be collected and improved to further estimate the subsurface movement of the probe 100, and thereby the lure.

The probe 100 may further be defined by the drag coefficient. The drag coefficient is preferably less than 0.5 in Re ^{˜}10⁴. The upper limit may further be restricted to 0.40, 0.30, 0.20, or 0.10, 0.09, 0.08 or 0.07 in Re ^{˜}10⁴.

For lowering the drag coefficient, the housing may have a nose portion in the travelling direction and a tail portion that tapers towards the lure 3. The cross section of the housing 101, taken transversal to the travelling direction of the probe 100, is preferably circular. However, other shapes are conceivable, for example elliptic. The largest transversal cross section (e.g. maximum diameter) of the housing 101 is preferably located in the first half of the probe 100, as seen along an axis coinciding with a stretched fishing line 2. To further optimize the drag coefficient, the largest transversal cross section is within a the one-third of the length of the housing, taken from the nose end (102a). This can be further limited to be within ¼, ⅕, or ⅙ from the nose end.

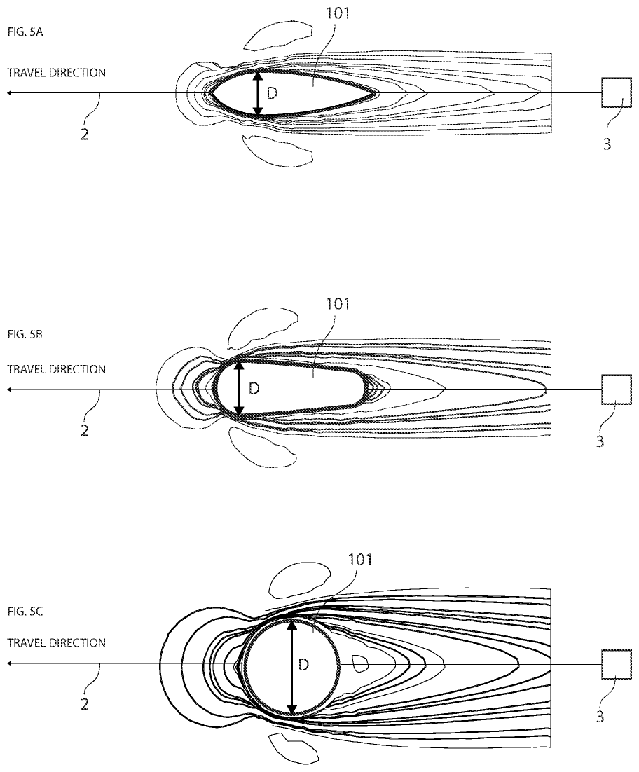

FIGS. 5A, 5B and 5C shows three different shapes of the probe housing providing different drag coefficients.

FIG. 5A shows an elongated shape of the housing 101 having a very low drag coefficient. The housing has pointed nose in the travelling direction and a tail portion that tapers towards the lure 3. A specimen was measured to have a drag coefficient as low as 0.041 in Re ^{˜}10⁴. The maximum diameter is about a one-third of the total length of the housing in the traveling direction as seen from the nose. This model can be useful as friction matters less but where turbulence should be the minimum, to minimize affecting the movement of the lure. For example, it can be advantageous when fishing with a lure that should travel straight at the same speed.

FIG. 5B shows an elongated shape of the housing with a rounded nose in the traveling. The housing has pointed nose in the travelling direction and a tail portion that tapers towards the lure 3. A specimen was measured to have a drag coefficient as low as 0.064 in Re ^{˜}10⁴. The maximum diameter is at about ⅙ of the total length of the housing as seen from the nose.

The shape of FIGS. A and 5B enables the probe to move through the water in a way that it minimizes interfering with the movement of the lure 3. The design makes the probe to travel through water without wobbling or rotating. It further, does not affect speed negatively or cause turbulence as it moves through the water.

FIG. 5C shows an embodiment with a spherical shaped housing 401. In one example a spherical housing has a drag coefficient of 0.47 in Re ˜10⁴. A spherical design of the probe also means a reduced friction surface between the probe and the water in all directions This can be useful when drag matters less, but where it is more important that the lure 3 should be able to move more freely in all directions, for example when fishing with lures 3 that should bounce along the bottom or creak quickly sideways.

The volume that the probe takes when submerged in water may be in the range of 1-50 cm3. The lower limit may be 1, 2, 4 4, 5, 6 or 7 cm3. The upper limit may be 50, 40, 30, 20, 15, 12, 10, or 9 cm3.

The weight of the probe is preferably in the range of 1-50 g. The lower limit may be 1, 2, 3, 4, 5, 6, or 7 g. The upper limit may be 50, 40, 30, 20, 15, 12, 10, or 9 g. A preferred range is 6-15 g.

The probe 100 buoyancy is affected by its total density. The density of the probe may in the range of 0.5-2 g/cm3. The density may be tailored for different applications. The lower limit may be 0.5, 0.6, 0.0.8, 0.9, 1.0, 1.1, 1.2, 1.3, or 1.5 g/cm3. The upper limit may be 2.0, 1.9, 1.8, 1.7, 1.6, 1.5, 1.4, 1.3, 1.2, 1.1, 1.0, 0.9, or 0.8 g/cm3.

In some embodiments, a positive buoyancy is desired. Even in the case of positive buoyancy, the probe will not function as a float due to its low weight. The lure 3 will ensure that they sink together. This can e.g. be achieved with a density in the range of 0-5-0.8 g/cm3. For instance, for heavy-duty fishing, white e.g. sea fishing. A positive buoyancy can be beneficial if the line is at risk of breaking. Then the probe will float up to the water surface and possibly give off an emergency light signal in order to be found.

In some embodiment a neutral or close to neutral buoyancy is desired. This can e.g be achieved with a density in the range of 0.8-1.2 g/cm3, preferably 0.9-1.1 g/cm3. The aim with a neutral buoyancy is to affect the movements of the lure 3 as little as possible.

In other embodiments, a negative buoyancy (sinking capacity) is desired. This can be e.g. be achieved with a density in the range of 1.2-2.0 g/cm3. For a higher sinking capacity, the range may be 1.5-2.0 g/cm3. A higher sinking capacity may be desirable, when you fish at large depths or when the product is used as an additional sinker. It may further be useful when the angler wants to reach a longer range, e.g. when fishing from the shoreline.

The probe may be designed to have adjustable buoyancy. Negative buoyancy can e.g. be achieved by clipping on weights having higher density than water to the housing 101. Positive buoyancy can e.g. be achieved by clipping on pieces having lower density than water to the housing to the housing 101.

1. A measuring probe (100) for a spinning or casting rod (1) comprising:
a housing (101);
connection means (102a, 102b) on the housing (101) for securing the measuring probe (100) to a fishing line (2) of the rod (1) above a lure (3);
at least one of:
an accelerometer (104) for measuring acceleration forces in three axes,
a gyroscope (105) to determine the angular position of the measuring probe (100),
a water pressure sensor (112), and
an active sonar unit (111);
a wireless communication unit (108), preferably Bluetooth for transmitting stored sensor data to an external device when the measuring probe (100) is above the water surface (5); and
a battery (110) for powering the measuring probe (100).

2. The measuring probe according to claim 1, wherein the housing (101) has a nose in a travelling direction and a tail for facing the lure (3), the tail tapering towards the lure (3).

3. The measuring probe according to claim 1, wherein the housing (101) is elongated.

4. The measuring probe according to according to claim 1, wherein the housing (101) is spherical.

5. The measuring probe according to claim 1, wherein the drag coefficient of the housing (101) is less than 0.5 in Re ^{˜}10⁴.

6. (canceled)

7. The measuring probe according to claim 1, wherein the density of the probe (100) is within the range of 0.5-2.0 g/cm³.

8. (canceled)

9. (canceled)

10. The measuring probe according to claim 1, wherein the measuring probe (100) is configured to move in a stable position such that it does not twist around the axis that would coincide with a stretched fishing line attached to the probe, such that a first lengthwise half (101a) of the housing (101) is facing the water surface (5), when traveling through the water.

11. The measuring probe according to claim 1, wherein the weight of the measuring probe (100) is distributed towards a second lengthwise half (101b) of the housing (101), such that at least two thirds of the weight is in the second half (101b).

12. The measuring probe according to claim 1, wherein the battery (110) is provided in the second half (101b).

13. The measuring probe according to claim 1, wherein the sonar unit is configured, once submerged, to send ultrasonic pulses (6) towards the water surface (5) and to receive returning pulses (7) from the water surface for determining the distance from the measuring probe (100) to the water surface (5).

14. The measuring probe according to claim 1, wherein the connection means (102a, 102b) comprises a through hole (102a, 102 b) at each short end of the housing (101), through which through holes a fishing line (2) can be drawn, a first through hole (102a) for facing a fishing rod and a second through hole (102b) for facing a lure (3).

15. The measuring probe according to claim 14, wherein,
the elongated housing (101) comprises a visual identification along the top of the first half (101a) to guide the user when threading the fishing line (2); and/or
the elongated housing (101) comprises a lengthways trace at the top of the first half (101a) running between the through holes (102a, 102b) to guide the fishing line.

16. The measuring probe according to claim 1, wherein the measuring probe (100) further comprises at least one of the following sensors:
a magnetometer (106) for measuring the direction of the probe in earths magnetic field;
two electrodes (114) for measuring the conductivity of the water, preferably determining a pH value of the water;
a light sensor (113) and a LED light (115) and for measuring the turbidity and/or color of the water; and
a thermometer (116) for measuring the temperature of the water.

17. (canceled)

18. A spinning or casting rod comprising:
a rod (1) with a fishing line (2);
a lure (3) secured to the end of the fishing line (2); and
a measuring probe (100) according to any one of preceding claims;
wherein the measuring probe (100) is secured to the fishing line (2) between the tip of the rod (1) and the lure (3) at a predetermined distance from the lure (3).

19. A method comprising the steps of:
providing a spinning or casting rod (1) with a fishing line (2);
securing the measuring probe (100) according to any one of claims 1-17 to the fishing line (2) between the tip of the rod (1) and the end of the fishing line; and
providing lure (3) to the end of the fishing line (2) at a predetermined distance from probe (100).

20. The method according to claim 19 comprising:
measuring acceleration forces in three axes affecting the measuring probe (100);
measuring an angular position of the measuring probe (100); and
measuring a water pressure.

21. The method according to claim 19, further comprising:
sending ultrasonic pulses (6) towards the water surface (5) and/or the bottom;
receiving returning ultrasonic pulses (7) from the water surface (5) and/or the bottom; and
determining a distance from the measuring probe (100) to the water surface (5) and/or the bottom based on the ultrasonic pulses (6, 7).

22. The method according to claim 19, wherein determining a depth of the lure (3) based on
information of angular position of the probe (100);
the water pressure and/or the ultrasonic determined distance from the measuring probe (100) to the water surface (5) and/or the bottom; and
the distance (H1) between the lure (3) and the measuring probe (100).

23. The method according to claim 19, further comprising at least one of the following steps:
measuring the direction of the probe (100) in earths magnetic field;
measuring the conductivity of the water, preferably determining a pH value of the water;
measuring the turbidity and/or color of the water; and
measuring the temperature of the water.

24. The method according to claim 19, further comprising:
storing sensor data; and
transmitting stored sensor data to an external device when the measuring probe is above the water surface.
